(19) United States
(12) Patent Application Publication
(10) Pub. No.: US 2010/0241992 A1
(43) Pub. Date: Sep. 23, 2010

(54) ELECTRONIC DEVICE AND METHOD FOR OPERATING MENU ITEMS OF THE ELECTRONIC DEVICE

(75) Inventor: WEI ZHANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/547,674

(22) Filed: Aug. 26, 2009

(30) Foreign Application Priority Data
Mar. 21, 2009 (CN) 200910301016.5

(51) Int. Cl. G09G 5/00; G06F 3/048; G09G 5/08

(52) U.S. Cl. 715/823; 345/157

(57) ABSTRACT

A method for operating menu items using an electronic device is provided. The electronic device includes a camera, a visual perception unit, a displaying unit, and a display screen. The displaying unit displays menu items on the display screen. The camera captures a visual image of the user's eyes when a user views one of the menu items. The visual perception unit obtains a visual focus position from the visual image by analyzing pixel values of the visual image, calculates a visual offset for calibrating visual focus position, and calibrates the visual focus position according to the calculated visual offset when the user views the menu item on the display screen.

### BACKGROUND

1. Technical Field

Embodiments of the present disclosure relate generally to methods and devices for operating menu items, and more particularly to an electronic device and method for operating menu items of the electronic device by using human visual perception.

2. Description of related art

Typically, when a user touches a menu item on a touch screen, a touch point needs to be confirmed by using human visual perception. However, the human visual perception may inaccurately confirm menu items because of the small area of the touch screen or because many menu icons may be displayed on the touch screen at the same time.

Accordingly, there is a need for an improved electronic device and method for operating menu items of the electronic device by using human visual perception, so as to enable the user to conveniently and accurately operate a desired menu item of the electronic device.

### BRIEF DESCRIPTION OF THE DRAWINGS

FIG. 1 is a schematic diagram of one embodiment of an electronic device having a visual perception feature.

FIG. 2 is a flowchart of one embodiment of a method for operating menu items of the electronic device of FIG. 1.

FIG. 3 is a flowchart of detailed descriptions of S20 in FIG. 2.

FIG. 4 is one embodiment of menu items displayed on a display screen of the electronic device of FIG. 1.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

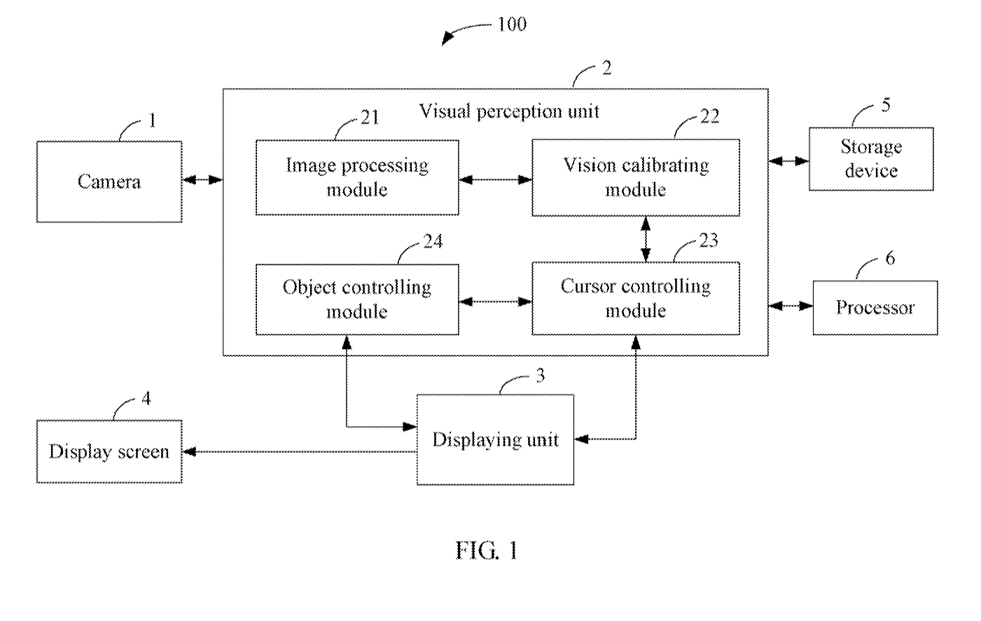

FIG. 1 is a schematic diagram of one embodiment of a electronic device 100 having a visual perception feature. Visual perception is the ability of a user to interpret external stimuli, such as visible light. In one embodiment, the visual perception feature is the ability of sensing or confirming a menu item displayed on a display screen 4 of the electronic device 100 when a user views the menu item. The electronic device 100 may include a camera 2, a visual perception unit 2, a displaying unit 3, a display screen 4, a storage device 5, and at least one processor 6. As shown in FIG. 1, the visual perception unit 2 may be electronically connected to the camera 1, the displaying unit 3, the storage device 5, and the processor 6. The displaying unit 3 is connected to the display screen 4. The above mentioned components may be coupled by one or more communication buses or signal lines. It should be apparent that FIG. 1 is only one example of an architecture for the electronic device 100 that can be included with more or fewer components than shown, or a different configuration of the various components.

The camera 1 is operable to capture a visual image of a user's eyes when the user views a menu item displayed on the display screen 4, and send the visual image to the visual perception unit 2. The visual perception unit 2 is operable to translate a visual focus position from the visual image, and calibrate the visual focus position when the user views the menu item displayed on the display screen 4. In the embodiment, the visual perception unit 2 is included in the storage device 5 or a computer readable medium of the electronic device 100. In another embodiment, the visual perception unit 2 may be included in an operating system of the electronic device 100, such as the Unix, Linux, Windows 95, 98, NT, 2000, XP, Vista, Mac OS X, an embedded operating system, or any other compatible operating system.

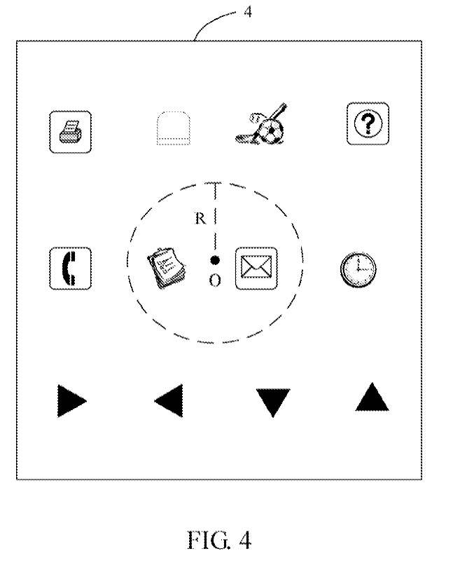

The displaying unit 3 is operable to generate a reference point that is used to calculate an visual offset, and display a plurality of menu items on the display screen 4. Referring to FIG. 4, each of the menu items corresponds to an application program for executing a corresponding function. In one embodiment, each of the menu items may be a menu icon, a logo, one or more characters, or a combination of the logo and the one or more characters. The displaying unit 3 is further operable display the reference point on the display screen when the visual offset needs to be calculated. In one embodiment, the visual offset includes a horizontal offset (denoted as “k”) and a vertical offset (denoted as “h”), and are used to calibrate the visual focus position to generate a calibrated position.

The storage device 5 stores the visual offset when the visual offset is calculated by the visual perception unit 2, and may store software program or instructions of the visual perception unit 2. In the embodiment, the storage device 5 may be a random access memory (RAM) for temporary storage of information and/or a read only memory (ROM) for permanent storage of information. The storage device 5 may also be a hard disk drive, an optical drive, a networked drive, or some combination of various digital storage systems.

In one embodiment, the visual perception unit 2 may include an image processing module 21, a vision calibrating module 22, a cursor controlling module 23, and an object controlling module 24. Each of the function modules 21-24 may comprise one or more computerized operations executable by the at least one processor 6 of the electronic device 100. In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. The modules described herein may be implemented as either software and/or hardware modules and may be stored in any type of computer-readable medium or other storage device.

The image processing module 21 is operable to control the camera 2 to capture a visual image of the user's eyes when the user views a menu item displayed on the display screen 4, and obtain a visual focus position from the visual image by analyzing pixel values of the visual image. The image processing module 21 is further operable calculate a visual offset that is used to calibrate the visual focus position. As mentioned above, the visual offset includes the horizontal offset “k” and the vertical offset “h.” In one embodiment, the image processing module 21 controls the camera 2 to capture a reference image of the user's eyes when the user views the reference point on the display screen 4, and calculates a first coordinate value (denoted as (X₁,Y₁)) of the reference point and a second coordinate value (denoted as (X₂,Y₂)) of the center point of the reference image. Thus, the image processing module 21 calculates the visual offset by performing the following formulas: k=X₂/X₁, and h=Y₂/Y₁.

The vision calibrating module 22 is operable to calibrate the visual focus position to generate a calibrated position according to the visual offset, and confirm a desired menu item displayed on the display screen 4 according to the calibrated position. In one embodiment, assuming that a coordinate value of the visual focus position is denoted as (X₀, Y₀), the vision calibrating module 22 calculates a coordinate value of the calibrated position (denoted as (X, Y)) by performing the following formulas: X=X₀+k*X₀, and Y=Y₀+h*Y₀.

The cursor controlling module 23 is operable to select a surrounding area of the calibrated position as a vision focused area, and determine whether the vision focused area is displayed on the display screen 4. In one embodiment, the vision focused area may be a circle, an ellipse, or a rectangle. Referring to FIG. 4, the vision focused area is a circle (denoted as “O”) as the vision focused area, whose radius is “R.” If the vision focused area is displayed on the display screen 4, the displaying unit 3 highlights the vision focused area on the display screen 4 if the vision focused area is displayed on the display screen 4. Otherwise, if the vision focused area is not displayed on the display screen 4, the displaying unit 3 controls the display screen 4 to work in a power saving mode, such as a display protection mode to save the power consumption in real time, for example.

The cursor controlling module 23 is further operable to determine whether any menu item appears in the vision focused area. If no menu item appears in the vision focused area, the camera 2 captures another visual image when the user moves the sight of viewing the display screen 4. Otherwise, the cursor controlling module 23 determines whether the vision focused area includes one or more menu items when any menu item appears in the vision focused area.

The object controlling module 24 is operable to enlarge the menu items when the total number of the menu items is more than one, and display the enlarged menu items on the display screen 4. After the enlarged menu items are displayed on the display screen 4, the controlling module 24 can highlight one of the enlarged menu items, and invoke/select a function feature corresponding to the enlarged menu item according to the eye movements.

The cursor controlling module 23 is further operable to determine whether a stay time of the vision focused area is greater than a predefined time period (e.g., 2 seconds) when the vision focused area stays at only one menu item. The stay time represents how long the vision focused area stays at a menu item, for example, the vision focused area can stay at the menu item for one second or any time. In one embodiment, the object controlling module 24 controls the menu item to perform a corresponding function if the stay time of the vision focused area is greater than the predefined time period. Otherwise, if the stay time is not greater than the predefined time period, the object controlling module 24 controls the menu item to be displayed on the display screen 4 for user's viewing.

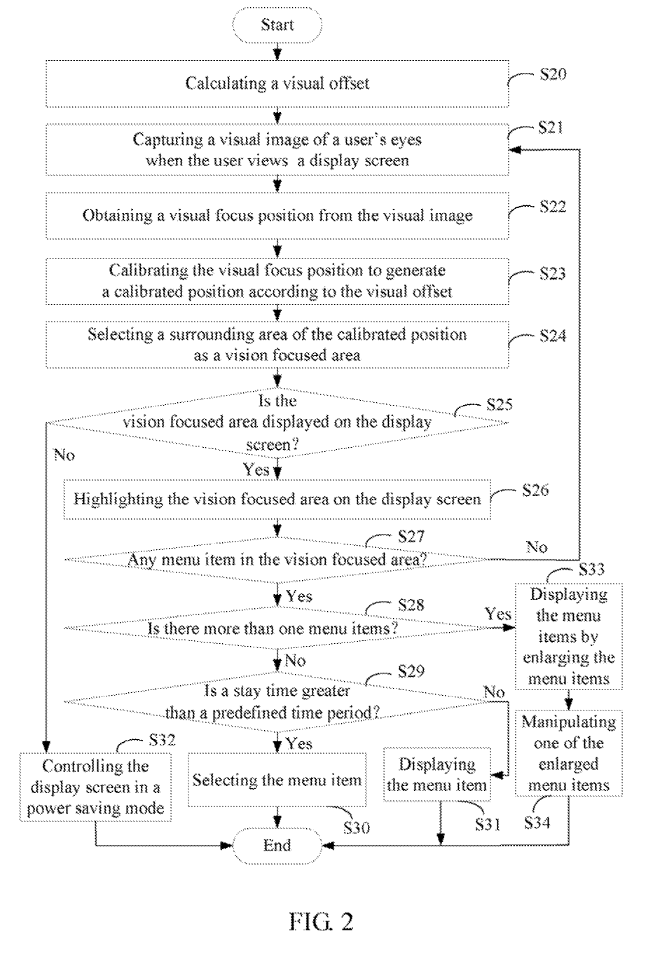

FIG. 2 is a flowchart of one embodiment of a method for operating menu items of the electronic device 100 as described in FIG. 1. Depending on the embodiment, additional blocks may be added, others removed, and the ordering of the blocks may be changed.

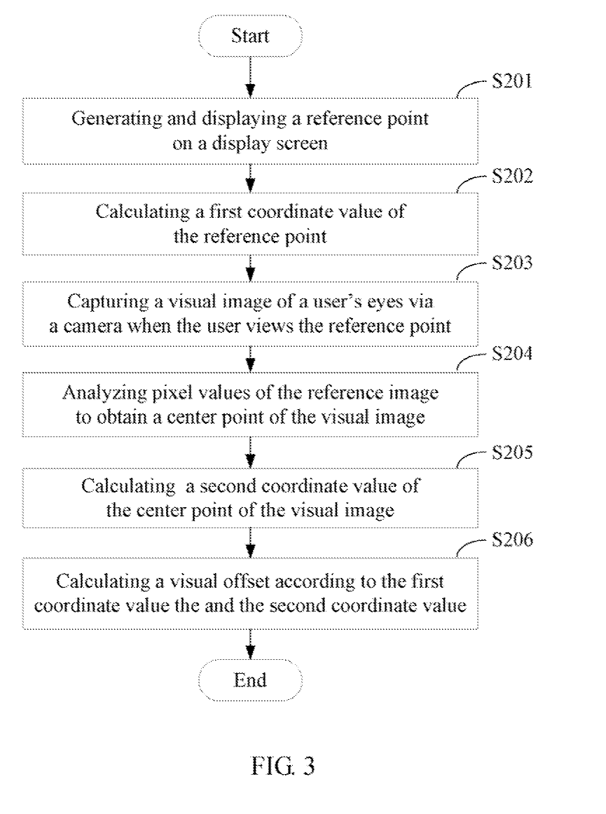

In block S20, the image processing module 21 firstly calculates a visual offset, and stores the visual offset into the storage device 5. In one embodiment, the visual offset includes a horizontal offset (denoted as “k”) and a vertical offset (denoted as “h”), and are used to calibrate visual focus position to generate a calibrated position. Detailed methods of calculating the visual offset are described as FIG. 3 below.

In block S21, the image processing module 21 controls the camera 2 to capture a visual image of the user's eyes when a user views a menu item displayed on the display screen 4. In block S22, the image processing module 21 obtains a visual focus position from the visual image by analyzing pixel values of the visual image. Referring to FIG. 4, the display screen 4 displays a plurality of menu items, each of the menu items represents an application program for executing a corresponding function. In one embodiment, each of the menu items may be a menu icon, a logo, one or more characters, or a combination of the logo and the one or more characters. If the user wants to select a menu item to perform the corresponding function, the user can view the menu item on the display screen 4.

In block S23, the vision calibrating module 22 calibrates the visual focus position to generate a calibrated position according to the calculated visual offset. An example with respect to the present disclosure, assuming that a coordinate value of the visual focus position is denoted as (X₀, Y₀), the vision calibrating module 22 then calculates a coordinate value (denoted as (X, Y)) of the calibrated position by performing the following formulas: X=X₀+k*X₀, and Y=Y₀+h*Y₀.

In block S24, the cursor controlling module 23 selects a surrounding area of the calibrated position as a vision focused area. In one embodiment, the vision focused area may be a circle, an ellipse, or a rectangle. Referring to FIG. 4, the vision focused area is a circle (denoted as “O”) as the vision focused area, whose radius is “R.” In block S25, the cursor controlling module 23 determines whether the vision focused area is displayed on the display screen 4. If the vision focused area is displayed on the display screen 4, in block S26, the displaying unit 3 highlights the vision focused area on the display screen 4. Otherwise, if the vision focused area is not displayed on the display screen 4, in block S32, the displaying unit 3 controls the display screen 4 to work in a power saving mode, such as executing a display protection mode to save the power consumption in real time, for example.

In block S27, the cursor controlling module 23 determines whether any menu item appears in the vision focused area. If no menu item appears in the vision focused area, the procedure returns to block S21 as described above. Otherwise, if any menu item appears in the vision focused area, in block S28, the cursor controlling module 23 determines whether the vision focused area includes one or more menu items.

In block S28, the cursor controlling module 23 determines whether a stay time of the vision focused area is greater than a predefined time period (e.g., 2 seconds) when the vision focused area includes only one menu item. The stay time represents how long the vision focused area stays at a menu item, for example, the vision focused area can stay at the menu item for one second or any times. If the stay time is greater than the predefined time period, in block S30, the object controlling module 24 selects the menu item to perform the corresponding function. Otherwise, if the stay time is not greater than the predefined time period, in block S31, the object controlling module 24 controls the menu item to be displayed on the display screen 4 for user's viewing.

In block S33, the object controlling module 24 enlarges the menu items when the total number of the menu items within the vision focused area is more than one, and displays the enlarged menu items on the display screen 4. After the enlarged menu items are displayed on the display screen 4, in block S34, the controlling module 24 can highlight one of the enlarged menu items, and invoke/select a function feature corresponding to the enlarged menu item according to the eye movements.

FIG. 3 is a flowchart of detailed descriptions of S20 in FIG. 2. Depending on the embodiment, additional blocks may be added, others removed, and the ordering of the blocks may be changed.

In block S201, the displaying unit 3 generates a reference point and displays the reference point on the display screen 4. The reference point is used to calculate the visual offset that includes the horizontal offset “k” and the vertical offset “h.” In block S202, the image processing module 21 calculates a first coordinate value of the reference point. For example, the first coordinate value can be denoted as (X₁,Y₁).

In block S203, the image processing module 21 controls the camera 2 to capture a reference image of the user's eyes when the user views the reference point on the display screen 4. In block S204, the image processing module 21 obtains a center point of the reference image by analyzing the pixel values of the reference image. In block S205, the image processing module 21 calculates a second coordinate value of the center point of the reference image. For example, the second coordinate value can be denoted as (X₂,Y₂).

In block S206, the image processing module 21 calculates the visual offset according to the first coordinate value (X₁,Y₁) and the second coordinate value (X₂,Y₂). In one embodiment, the image processing module 21 calculates the horizontal offset “k” and the vertical offset “h” by performing the following formulas: k=X₂/X₁, and h=Y₂/Y₁.

All of the processes described above may be embodied in, and fully automated via, functional code modules executed by one or more general purpose processors of electronic devices. The functional code modules may be stored in any type of readable medium or other storage devices. Some or all of the methods may alternatively be embodied in specialized the electronic devices.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a camera electronically connected to a display screen;
a displaying unit connected to the display screen, and operable to display a plurality of menu items on the display screen; and
a visual perception unit connected to the displaying unit, the visual perception unit comprising:
an image processing module operable to control the camera to capture a visual image of a user's eyes when the user views the menu items, obtain a visual focus position from the visual image by analyzing pixel values of the visual image, and calculate a visual offset that is used to calibrate the visual focus position;
a vision calibrating module operable to calibrate the visual focus position to generate a calibrated position according to the visual offset;
a cursor controlling module operable to select a surrounding area of the calibrated position as a vision focused area, detect a stay time when the vision focused area stays at one of the menu items, and determine whether the stay time is greater than a predefined time period; and
an object controlling module operable to select the menu item to perform a corresponding function if the stay time is greater than the predefined time period, or control the menu item to be viewed by the user if the stay time is not greater than the predefined time period.

2. The electronic device according to claim 1, wherein the displaying unit is further operable to highlight the vision focused area on the display screen, and control the display screen to work in a power saving mode.

3. The electronic device according to claim 1, wherein the cursor controlling module is further operable to determine whether a total number of the menu items within the vision focused area is more than one, enlarge the menu items if the total number of the menu items is more than one, and display the enlarged menu items on the display screen.

4. The electronic device according to claim 1, wherein the displaying unit is further generate a reference point, and display the reference point on the display screen.

5. The electronic device according to claim 4, wherein the image processing module is further operable to control the camera to capture a reference image of the user's eyes when the user views the reference point, and calculate a first coordinate value of the reference point and a second coordinate value of a center point of the reference image, and calculate the visual offset according to the first coordinate value and the second coordinate value.

6. The electronic device according to claim 1, wherein the visual offset comprises a horizontal offset and a vertical offset.

7. A method for operating menu items of an electronic device, the method comprising:
calculating a visual offset for calibrating visual focus positions;
controlling a camera to capture a visual image of a user's eyes when the user views a menu item displayed on a display screen of the electronic device;
obtaining a visual focus position from the visual image by analyzing pixel values of the visual image;
calibrating the visual focus position to generate a calibrated position according to the calculated visual offset;
selecting a surrounding area of the calibrated position as a vision focused area;
detecting a stay time when the vision focused area stays at one of the menu items;
determining whether the stay time is greater than a predefined time period; and
selecting the menu item to perform a corresponding function if the stay time is greater than the predefined time period; or
controlling the menu item to be viewed by the user if the stay time is not greater than the predefined time period.

8. The method according to claim 7, further comprising:
determining whether the vision focused area is displayed on the display screen; and
highlighting the vision focused area on the display screen if the vision focused area is displayed on the display screen; or
controlling the display screen to work in a power saving mode if the vision focused area is not displayed on the display screen.

9. The method according to claim 7, further comprising:
determining whether a total number of menu items within the vision focused area is more than one;
enlarging the menu items if the total number of the menu items is more than one; and
displaying the enlarged menu items on the display screen.

10. The method according to claim 7, wherein the step of calculating a visual offset comprises:
generating a reference point;
displaying the reference point on the display screen;
controlling the camera to capture a reference image of the user's eyes when the user views the reference point;
calculating a first coordinate value of the reference point and a second coordinate value of a center point of the reference image; and
calculating the visual offset according to the first coordinate value and the second coordinate value.

11. The method according to claim 7, wherein each of the menu items is selected from the group consisting of a logo, one or more characters, or a combination of the logo and the one or more characters.

12. A readable medium having stored thereon instructions that, when executed by at least one processor of an electronic device, cause the processor to perform a method for operating menu items of the electronic device, the method comprising:
calculating a visual offset for calibrating visual focus positions;
controlling a camera to capture a visual image of a user's eyes when a user views a menu item displayed on a display screen of the electronic device;
obtaining a visual focus position from the visual image by analyzing pixel values of the visual image;
calibrating the visual focus position to generate a calibrated position according to the calculated visual offset;
selecting a surrounding area of the calibrated position as a vision focused area;
detecting a stay time when the vision focused area stays at one of the menu items;
determining whether the stay time is greater than a predefined time period; and
selecting the menu item to perform a corresponding function if the stay time is greater than the predefined time period; or
controlling the menu item to be viewed by the user if the stay time is not greater than the predefined time period.

13. The medium according to claim 12, wherein the method further comprises:
determining whether the vision focused area is displayed on the display screen; and
highlighting the vision focused area on the display screen if the vision focused area is displayed on the display screen; or
controlling the display screen to work in a power saving mode if the vision focused area is not displayed on the display screen.

14. The medium according to claim 12, wherein the method further comprises:
determining whether a total number of menu items within the vision focused area is more than one;
enlarging the menu items if the total number of the menu items is more than one; and
displaying the enlarged menu items on the display screen.

15. The medium according to claim 12, wherein the visual offset is calculated by means of:
generating a reference point;
displaying the reference point on the display screen;
controlling the camera to capture a reference image of the user's eyes when the user views the reference point;
calculating a first coordinate value of the reference point and a second coordinate value of a center point of the reference image; and
calculating the visual offset according to the first coordinate value and the second coordinate value.

16. The medium according to claim 12, wherein each of the menu items is selected from the group consisting of a logo, one or more characters, or a combination of the logo and the one or more characters.
